(19) United States
(12) Patent Application Publication
(10) Pub. No.: US 2023/0027577 A1
(43) Pub. Date: Jan. 26, 2023

(54) Safe Path Planning Method for Mechatronic Systems

(71) Applicant: Kontrol GmbH, Linz (AT)

(72) Inventor: Michael Naderhirn, Elkridge, MD (US)

(21) Appl. No.: 17/786,109

(22) PCT Filed: Dec. 16, 2020
(86) PCT No.: PCT/EP2020/086588

§ 371 Date: Jun. 16, 2022

Related U.S. Application Data
(60) Provisional application No. 62/948,595, filed on Dec. 16, 2019.

(51) Int. Cl. B60W 30/095

(52) U.S. Cl. CPC B60W 30/095; B60W 2554/20; B60W 2554/40; B60W 2554/402

(57) ABSTRACT

A method for controlling mechatronic systems is described herein. In accordance with one embodiment the method includes planning a nominal path for a mechatronic system using an automatic path planner, receiving information concerning one or more objects detected in the surrounding environment of the mechatronic system and calculating one or more occupancy sets corresponding to the one or more detected objects, and detecting whether the nominal path violates at least one of the one or more Occupancy Sets. In one embodiment, the occupancy sets may represent theoretic system states of the mechatronic system which are potentially occupied by the stationary and dynamic objects at a specific time. Furthermore, a corresponding control system is described.

### CROSS-REFERENCE TO RELATED APPLICATIONS

This application claims the benefit of U.S. Provisional Application No. 62/948,595 filed Dec. 16, 2019, which is hereby incorporated by reference in its entirety.

### TECHNICAL FIELD

The following disclosure describes a fail operational control method for mechatronic systems.

### BACKGROUND

Reference is made to the publications US 2018/0373251 A1, U.S. Pat. No. 9,645,577 B1, and M. Althoff, M. Koschi, C. Pek, “An Online Verification Framework for Motion Planning of Self-driving Vehicles with Safety Guarantees” in: AAET Conference—Automatisiertes und vernetztes Fahren, Braunschweig, January 2019 (Althoff et al.).

In safety critical standards there are different architecture choices and rules which can be implemented by a developer in order to make a safety critical system safe. Such standards include industry related standards such as ISO 26262 for automotive applications, ISO 61598 for industrial applications, and ARP4754/DO-178C/DO-254 for aeronautic applications. The choice of such architecture is the result of a process usually starting with a hazard and risk analysis (HARA) which results in an industry related quantification of the risk. Based on these results, several standards suggest a system architecture suitable to mitigate the related risk.

### SUMMARY

A method for controlling mechatronic systems (e.g. an autonomous car) is described herein. In accordance with one embodiment the method includes planning a nominal path for a mechatronic system using an automatic path planner, receiving information concerning one or more objects detected in the surrounding environment of the mechatronic system and calculating one or more occupancy sets corresponding to the one or more detected objects, and detecting whether the nominal path violates at least one of the one or more Occupancy Sets. In one embodiment, the occupancy sets may represent theoretic system states of the mechatronic system which are potentially occupied by the stationary and dynamic objects at a specific time. Furthermore, a corresponding control system is described.

### BRIEF DESCRIPTION OF THE DRAWINGS

The embodiments described herein can be better understood better with reference to the following drawings and descriptions. The components in the figures are not necessarily to scale; instead, emphasis is placed upon illustrating the principles of the invention. Moreover, in the figures, like reference numerals designate corresponding parts. In the drawings:

FIG. 1 shows a so-called 2002D architecture design as used in different industries as proposed by different safety critical standards

FIG. 2 shows a so-called 1001D architecture design as proposed by different safety critical standards.

FIG. 3 depicts an implementation in accordance with an exemplary embodiment in a 2002D architecture setting with two channels (channel A and channel B) where each channel is implemented as a 1001D architecture.

FIG. 4 depicts an exemplary implementation of a 1001D fail-safe architecture to control a mechatronic system for the NOMINAL_x.

FIG. 5 shows the time vector

FIG. 6 shows the nominal path planner NOMINAL_x

FIG. 7 depicts an example where the stationary object is represented through a straight line like y=kx+d.

FIG. 8 depicts the connection matrix mapping the inputs to variables.

FIG. 9 depicts the graphical representation of a straight line property for one state of a trajectory generated by NOMINAL_x

FIG. 10 depicts the functionality of the SWITCH where Channel_A has a higher priority than Channel_B.

### DETAILED DESCRIPTION

Striving for a mechatronic system that can reliably find a safe and cost-efficient path in a complex environment like ground or air traffic with human drivers/pilots has been pursued for years. There are a variety of different proposals how to comply with such requirements. In the following a few approaches will be discussed.

A safety framework to verify the safety of each planned trajectory on-the-fly has been proposed by Althoff et al., who use formal methods to handle uncertain measurements and future behaviors of traffic participants and disturbances acting on an mechatronic system (i.e. the currently considered dynamic object).

The mentioned safety framework is (functionally) arranged parallel to the motion planner, or nominal path planner, and is supposed to verify the nominal path and provide a fail-safe trajectory in case the verification fails.

The system receives one or more trajectories from the nominal path planner and selects the trajectory which has been verified best using a cost function. The verification is based on the calculation of reachable sets of states for the mechatronic system and occupancy sets for stationary and dynamic objects at a certain point in time for a certain time period.

The physically reachable states of the mechatronic system are called “reachable set”. The reachable set represent—for a specific sample time—those system states of the mechatronic system that are physically viable. The calculation is based on the last measured state of the mechatronic system and the mathematical model of the mechatronic system.

The occupancy sets represent the theoretic states of the mechatronic system that are—for a specific sample time—potentially occupied by the stationary and dynamic object and thus not available for the mechatronic system. Here, “occupied” does not necessary that the objects physically occupy the states. The objects may also occupy the states in the Occupancy Set due to specified rules (e.g. safety clearance as defined in traffic rules, etc.). For stationary objects this can contain the last measurement from the sensor, additional information such as geometric information and occupied positions associated traffic rules, e. g. traffic signs, road lanes, . . . , map and/or data base information about the stationary objects, e. g. object dimensions and positions. For dynamic objects this can contain the reachable set of the dynamic object based on the last measurement from the sensor, its predicted trajectory, additional information such as the mathematical model of the dynamic object received from a database, dimensions of the dynamic object, traffic rules associated with, e.g., road lanes and road signs, a set of possibly occupied positions. The “occupancy set”, is calculated for each object and can consider possible disturbances of the measurements.

Lastly the reachable sets and the occupancy sets are checked for intersections with the planned trajectory. When the trajectory is a subset of (or intersects with) the reachable set and does not violate (or not intersect with) the occupancy sets, the trajectory is successfully verified.

In order to reduce the computation, the safety framework calculates only the first part of the nominal path in detail. The remaining second part of the (longer) nominal path is calculated with less assumptions and much simpler models. To increase the safety, fail-safe trajectories may regularly be calculated along the (shorter) first part of the trajectory. First the branch location of a fail-safe trajectory is defined by use of binary search and, second, the optimal shape of the fail-safe trajectory is calculated by convex trajectory optimization. Finally, the Occupancy Set and the intersections check are performed for the short trajectory and its fail-safe trajectory branches. In case of a failure, the last viable fail-safe trajectory branch will be executed.

In the publication US 2018/0373251 A1 (2018) a fault tolerant system setup for a trajectory planner has been proposed. This setup relies heavily on redundant layout utilizing the non-homogenous redundancy principle as suggested by ISO 26262-9 (5.4). The system comprises at least three subsystems: two redundant subsystems labelled as COM, “commander”, MON, “monitor”, and one DECIDE, “decision subsystem”. COM and MON use different methods to determine a safe trajectory. COM generates a trajectory based on sensor data, while MON generates a “safe envelope” based on the same sensor data, or alternatively, other (independent) sensor data in order to utilize the independence principle as suggested by ISO 26262-9 (5.4). The DECIDE subsystem decides whether the trajectory generated by the COM subsystem is safe by verifying whether this trajectory is within the “safe envelope” of the MON subsystem. The verification is performed in a “trajectory verification stage”. In the case of negative verification an emergency stop will be initiated by the DECIDE subsystem. This system architecture is very similar to the architecture 1oo2D suggested by EN 61508-6(B.3).

Different variations of this system architecture where the “trajectory verification stage” is moved from the DECIDE subsystem to the MON subsystem have been proposed. This has been done in order to move the complexity away from the DECIDE subsystem, which is assigned an ASIL-D level (Automotive System Integrity Level D), thus utilizing the lower complexity principle as suggested by ISO 26262-9 (5.4). There is also a proposed variant with a fourth subsystem designated as FB, “fall back”, subsystem. This subsystem is parallel to the COM and MON subsystems and generates emergency trajectories which are used in case the COM generated trajectory is not verified. The FB subsystem utilizes the safety mechanisms principle as suggested by ISO 26262-4 (6.4.2).

For a safe information distribution and transfer between the subsystems, a mechanism referred to as PROT has been suggested. PROT implements well-known concepts like cryptographically signed or checksum verified information transfer, thus complying with error detection principle as suggested by ISO 26262-6 (9.4.2) or data communication according EN 62508-2 (7.4.11).

In order to reduce the probability of false negatives due to divergent sensor data received by COM and MON subsystems, three stages MRG,“information merging stage”, AGR1, “information agreement stage 1”, and AGR2, “information agreement stage 2” are introduced into the COM and MON subsystems. These stages are responsible for the merging of the preprocessed and fused sensor data in order to guarantee similar sensor inputs in both subsystems. In order to achieve the merging, two operations can be used, namely the “set-theoretic superset operation” that creates a combined area and the “set-theoretic cut-set operation” that creates an overlapping area of the sensor derived real-time images.

In the publication U.S. Pat. No. 9,645,577 B1 (2017) a method to facilitate vehicle driving and vehicle self-driving has been proposed. Thereby they differentiate between the following applications: autonomous driving, and evaluation of human driver performance by monitoring it with data recording and feedback.

The underlying method for all these applications involves the generation of a finite set of vehicle candidate trajectories and the subsequent selection of a putative optimal trajectory from among these candidate trajectories.

The generation of the candidate trajectories is based on the information about the world state (state of the vehicle) and the state of the environment (states of dynamic and static objects). The basic idea is, inter alia, to generate a finite set of candidate trajectories which sufficiently covers all possible trajectories.

The subsequent selection of a putative optimal trajectory from the finite set of vehicle candidate trajectories is based on a determination of a minimum cost path. The costs are associated with violations of rules of operation, sequences of transitions between successive states of the trajectory, path geometry, logics, efforts and dynamic efforts. The costs are represented as an array containing several numerical entries, each entry is correspondent to a rule priority level (value proportional to rule violation) or to a function of the vehicle's trajectory (fuel consumption, travel time, path length . . . ), whereby the prioritized and weighted rules are expressed in a formal language such as Linear Temporal Logic (LTL), Computation Tree Logic (CTL), or p-calculus. One concept of how rules available in the form of a textual description can be converted into a digital equivalent is explained, for example, in the publication WO 2017/202906 A1, which is herein incorporated by reference in its entirety.

In order to keep up with the dynamic environment and the changing vehicle position, the vehicle states, the finite set of vehicle candidate trajectories and the cost assessments are iteratively updated. The intervals between the time instances can range from 0.2 to 2 seconds.

In case of autonomous driving, the feedback control policy is based on the selected putative optimal trajectory and determines commands to control the vehicle accordingly. In the case of evaluation of human driver performance, the actual trajectory of the vehicle is monitored for a given time period and then compared with the putative optimal trajectory. Thereby one or more performance metrics can be evaluated, and the results may be shown on an in-vehicle display or recorded for further evaluation and documentation.

With the embodiments described below, fail operational control of a mechatronic system may be realized to conform to safety critical standards.

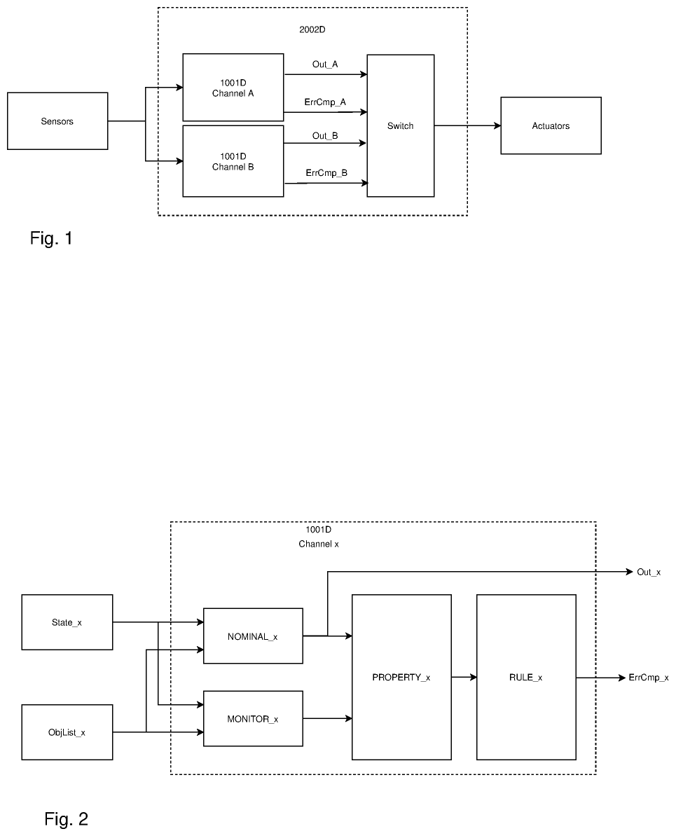

To achieve conformance to safety critical standards with highest criticality (e. g. ASIL-C/D automotive, SIL-3/4-machinery, DAL-A/B—aeronautic, or similar) a so-called 2002D architecture approach can be used. FIG. 1 depicts one approach of a 2002D architecture, which comprises two channels (parallel signal paths) labelled “Channel A” and “Channel B” in the example of FIG. 1. Each channel is typically implemented using a 1001D fail-safe architecture. A key property of the 2002D architecture is that either of the two channels (Channel A or Channel B) fails safe in the case of a fault condition. If a compare error (see FIG. 1, error signals ErrCmp_A, ErrCmp_B) is signaled by the failed channel, the switch labelled “Switch” switches to the healthy channel (i.e., forwards either Out_A or Out_B to Actuators) which keeps the system operational. Such a system condition is also referred to as fail-operational. In normal operation, both channels, Channel A and Channel B, are active, but only one of both channels, or a prioritized channel, is activated. In the rare case that both channels fail, a backup control may be activated. Each of the two channels could exist as physically distributed 1001D nodes on the same network. Collaboratively, they behave as a 2oo2D system.

FIG. 2 illustrates one example of a 1001D architecture “Channel x” which is a simplex architecture that securely fails safe during fault conditions. This is achieved by checking the output of NOMINAL_x (nominal path planner) against the output of MONITOR_x (monitoring system generating the reachable and occupancy sets) in the PROPERTY_x module. The results of PROPERTY_x are then evaluated using formal logic in the RULE_x. In the case of detecting an internal error the RULE_x module sets a ErrCmp signal ErrCmp_x. To apply specific properties and rules MONITOR_x. PROPERTY_x and RULE_x can be configured with CONFIGURATION_x during the startup or application of the system. CONFIGURATION_x can be a configuration file or any remote link. It contains a set of properties and rules which are applied during the application of the system. 1001D does not solve the fault tolerance and availability problems, but it can be setup to fail in a predictable and safe way, so it is appropriate for use as a fail-safe channel.

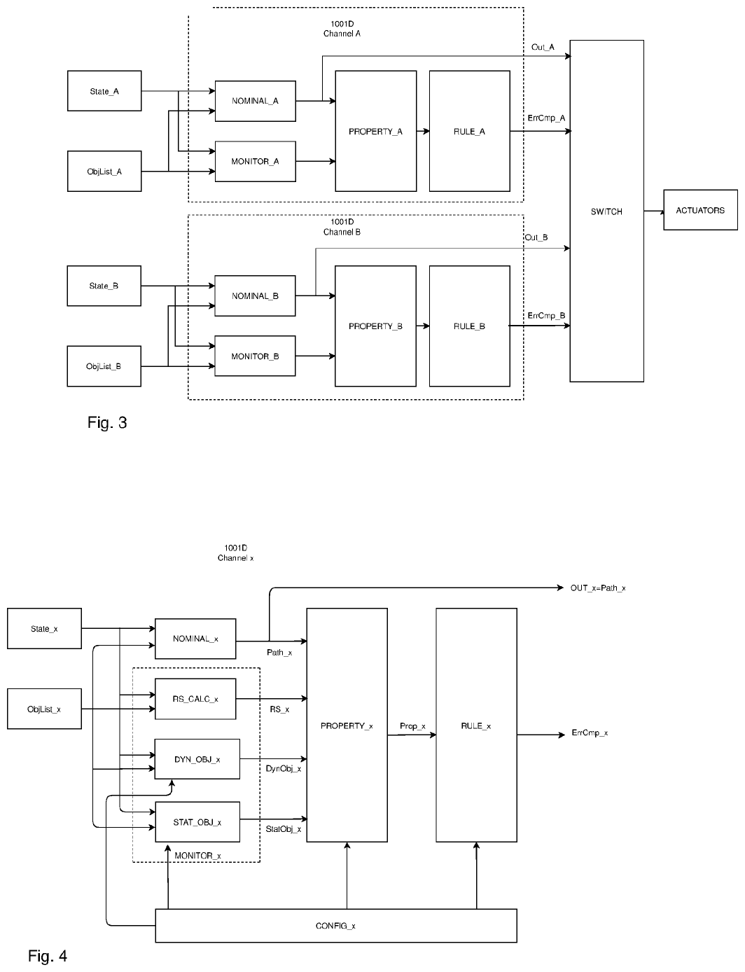

FIG. 3 depicts an exemplary implementation in accordance with one embodiment within a 2002D architecture setting with two channels (Channel A and Channel B) where each channel is implemented using a 1001D architecture as discussed above with referent to FIG. 2. The inputs to the channels are the predicted system state State_A, State_B of the mechatronic system and an object detection list ObjList_A, ObjList_B. The inputs to channel A and channel B may be computed independently of each other or may be the result of one single computation. The system state of the mechatronic system reflects its dynamic physical properties, usually described through differential equations, its uncertainties, the system input and its uncertainties. An object list may contain a list of detected objects consisting of object label (OL—name of object), object detection probability (ODP—probability that the detected object is represented by the detected object name in the object label), measurements (e. g. the object position, velocity, etc.), and the measurement uncertainties (e. g. standard variance, custom uncertainty distribution).

FIG. 4 depicts an exemplary implementation of a 1001D fail-safe architecture to control a mechatronic system. For implementing the NOMINAL_x block (e.g., x=A, B) a commonly known controller (e.g., P, PI, PID controller, etc.), a path planner (e. g. RRT*, BIT*, AStar, Motion library, etc.), and/or even a model, which has been trained by machine learning methods (Deep neural network—DNN, etc.), or any other common method used to control a mechatronic system may be used. The monitor block MONITOR_x (e.g. x=A, B) includes three subsystems to calculate the reachable set of the mechatronic system—subsystem RS_CALC_x; the properties of the stationary objects, STAT_OBJ_x; and the properties and/or reachable sets of dynamic objects, also called occupancy set, DYN_OBJ_x. All the subsystems RS_CALC_X, STAT_OBJ_x, and DYN_OBJ_x receives and use the measured system state (State_x) and the object list (ObjList_x) as inputs. The results Path_x, RS_x, StatObj_x, and DynObj_x are then forwarded to the PROPERTY_x subsystem. The result Prop_x provided by the PROPERTY_x subsystem is then used as input for RULE_x to calculate ErrCmp_x. The additional output Out_x of the Channel_x is the result of NOMINAL_x which is Path_x. In the case that NOMINAL_x includes a white box method, e. g. uses a mathematical model (e. g. a path planner) to calculate the result, the RS_CALC_x subsystem doesn't need to be a part of MONITOR_x. In the case NOMINAL_x contains a grey box (uses a mathematical model partially) or a black box (e. g. DNN or any other data-based methods, does not contain any information about the mathematical method) the RS_CALC_x subsystem needs to be a part of the MONITOR_x. The DYN_OBJ_x, STAT_OBJ_x, PROPERTY_x, and RULE_x subsystems can be configured individually using the CONFIG_x subsystem.

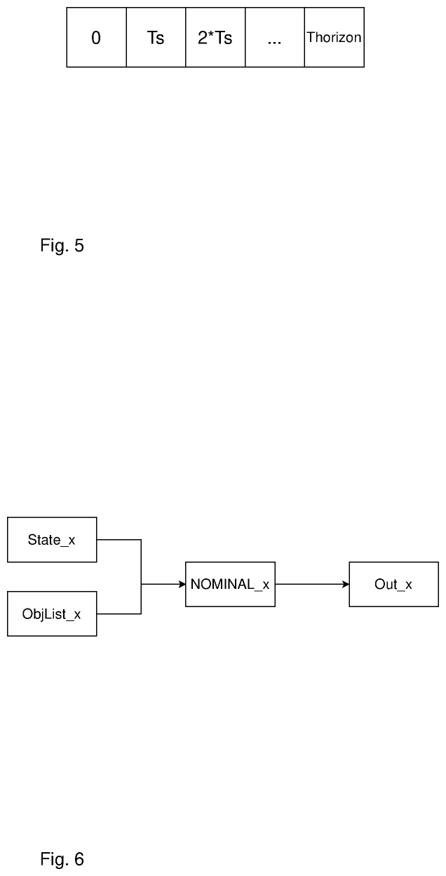

The calculations of all subsystems can either be done in two operational modes, which are a control mode and a predictive mode. The control mode uses the last measurement and the following sample time Ts. The predictive mode is also based on the last measurement and calculations done according to a time vector t. FIG. 5 depicts the time vector t where the entry 0 is the time zeros reflecting the last measurement and the entries containing Ts are multiple of Ts reflecting time steps in the future. The last entry is the time horizon “Thorizon” which is the time where the prediction ends. The first two entries are the one necessary for the control mode and do not necessarily require model information to calculate the output of the subsystem. In contrast, the predictive mode typically does require a model information to calculate the output of the subsystem. Model information is a mathematical description of the mechatronic system which should be controlled by the invention. The mathematical description can be a differential equation, state machine or any other mathematical method describing the system behavior. The computation of both control and the predictive mode is typically done on a control computer which usually operates in real time.

FIG. 6 depicts the NOMINAL_x subsystem as well as its inputs and outputs. Depending on the operational mode mentioned above, NOMINAL_x can provide different functionalities. The input to NOMINAL_x is the last measured or predicted state of the mechatronic system (State_x) and the object list (ObjList_x). In control mode it might contain known controllers, a model trained through machine learning methods, or any other control method requiring model information about the mechatronic system, resulting only in an output for the next sample time Ts to Out_x. This mode is typically used in state-of-the-art control applications. In case of predictive mode NOMINAL_x calculates and outputs a trajectory, predicted from time 0 to Thorizon, to Out_x. The trajectory is typically calculated using a path planner, a model trained through machine learning methods, or any prediction method. Additionally, the path planner may include several layers, which might require additional inputs or configuration parameters.

The purpose of RS_CALC_x (see FIG. 4) is to calculate the physical limits of the mechatronic system based on the mathematical model of the system and the last measured state. RS_CALC_x is only required if the trajectory derived from NOMINAL_x is not calculated using a mathematical model of the mechatronic system (e. g., using a grey box or black box model). The calculation of the physical limits of the mechatronic system requires a mathematical model of mechatronic system which describes its physical dynamic behavior. The calculation of the physical limit is also called the reachable set calculation. This can either be done offline or online. With offline it is meant that the computation is performed on a configuration computer which is not necessarily the control computer and the computation is not done in real time. With online it is meant that the computation is performed on the control computer in real time. In the case it is done offline, the reachable set can be calculated using the numerical method by solving e. g. the Hamilton-Jacobi partial differential equation (HJ equation). The boundaries of the resulting reachable set are the final states of the solution of the HJ equation which are connected through a mesh. The mesh is saved in a configuration file which is then used on the control computer. When the control computer is initiated, the mesh is loaded in the RAM of the control computer. If a new state measurement is received by RS_CALC_x, then the mesh stored in the RAM is used to calculate the boundaries of the relevant part of the reachable set. In contrast, if there is an analytical solution available to calculate the boundaries of the reachable set of the mathematical model of the mechatronic system, then the calculation can be done online without the need of using the offline calculation each time a new state measurement is available. Another way to calculate the reachable set can be done through models trained with machine learning methods. The final representation of the reachable set can be an occupancy grid, geometric functions, or any other mathematical way to represent the boundary of the reachable set.

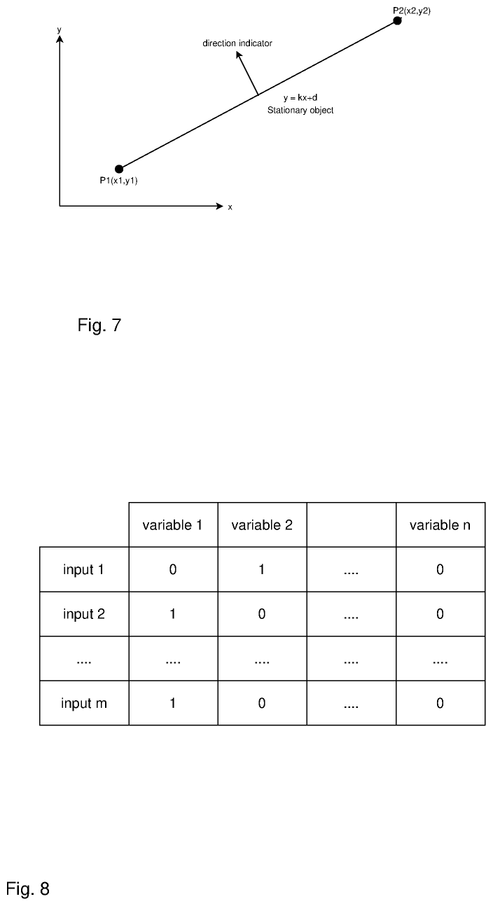

The purpose of STAT_OBJ_x (see FIG. 4) is to calculate the boundaries of stationary objects which do not have any dynamic properties. The representation of such stationary objects can be general functions e. g. y=f(x) in a 2-dimensional case, z=f(x,y) in a 3-dimensional case or any other multidimensional function which does not change its properties over time. Stationary objects can also be models trained through machine learning. Another property of stationary objects is that it typically includes an indication vector showing either in the direction where the mechatronic system is allowed to go or is not allowed to go. Typically, the parameter of the representation of stationary objects are the result of measurements which might contain uncertainties. FIG. 7 depicts an example where the stationary object is represented through a straight line like y=kx+d. The direction indicator in the example shows the direction where the state of the mechatronic system is not allowed to be. The two points P1(x1,y1) and P2(x2,y2) indicate the measurements received from a perception or a sensor. The parameters of the representation of the straight line are then calculated either directly or through an alternative method (e. g. numerical parameter estimation, or the like). In the case that a measurement also contains uncertainties like P(x,y,dx,dy) the uncertainties can be used to calculate an uncertainty along the representation of the stationary object which can be an occupancy grid. Uncertainties can be given by defining a variance, a covariance matrix or any other common uncertainty distribution.

The purpose of DYN_OBJ_x (see FIG. 4) is to calculate the boundaries of dynamic objects which do have dynamic properties. Dynamic properties can be state properties which change over time. The representation of such dynamic objects can be general differential equations, models trained through machine learning methods, or forward or backward reachable sets. To predict the vehicle state until Thorizon typically a tracking filter and/or a forward reachable set and/or a combination of both can be used. A different approach could be to estimate potential states for Thorizon and then use backwards reachable sets to check if the measured state is reachable. Additional information which can be used are digital maps to limit the boundaries of the reachable sets and/or precalculated reachable sets for the dynamic objects. The input to DYN_OBJ_x are measurements and/or predicted trajectories of dynamic objects, which can be either raw sensor information, the output of a perception module, or the output of tracking filters. The input can also contain measurement or prediction uncertainties as described above. The output of DYN_OBJ_x are the predicted states of the dynamic objects either as trajectories and/or reachable sets.

The purpose of PROPERTY_x (cf. FIG. 4) is to evaluate if a trajectory, planned through NOMINAL_x, fulfills the requirements defined through property rules. The input to PROPERTY_x are the outputs from NOMINAL_x, STAT_OBJ_x, and DYN_OBJ_x. The result is a vector containing the result of all evaluation of all properties. A property rule is a rule which describes a property for the mechatronic system. The definition of the property rules follows a predefined formal language. As an example:

P1: The mechatronic system should not cross a straight line

P2: The mechatronic system should not go faster than a specific velocity v_tresh.

Following a conversion of the properties according some predefined formal language into a digital version results to:

P1: Normal_distance(mechatronic_system,straight_line)>0

P2: v_mechatronic_system<v_tresh

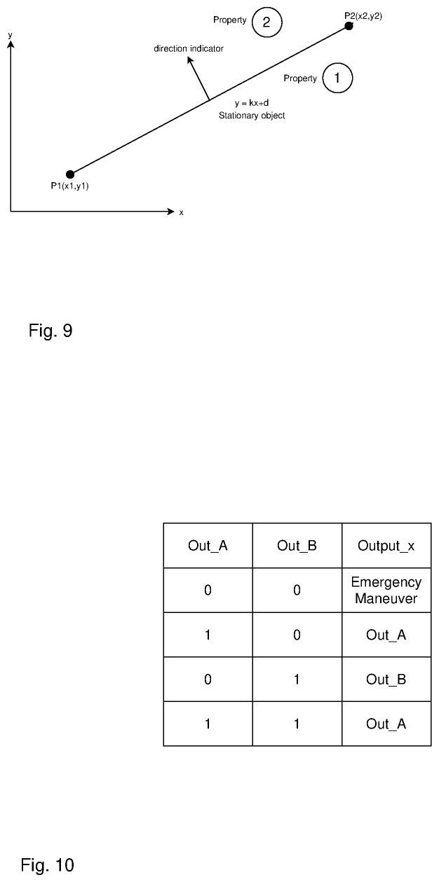

The property rules which should be applied in PROPERTY_x will be configured through CONFIGURE_x. This can be done either by loading a configuration file containing the property rules or by any other means e. g. database or internet.
The conversion of the written properties into its digital form can be done manually, semi-automatic or automatic. Suitable approaches therefore are as such known and not discussed herein in greater detail. The set of functions used in the digital version of the properties is herein referred to as “dictionary”. If a function is not part of an already existing dictionary, then they must be implemented manually or using model-based design tools. It may be advisable to use names for the functions which describe their purpose. Variables defined in the properties and in the interface of the functions must be associated to the inputs of PROPERTY_x. This can be done with a connection matrix which is configured at the startup of PROPERTY_x as depicted in FIG. 8. An interpreter is used to execute the digital form of each property (P1, P2, etc.) either on a CPU, parallelized on a GPU, or parallelized and pipelined on a FPGA or ASIC. The execution of the properties can be done using anonymous functions like unary or binary function. This requires the digital properties to be converted into an executable format. FIG. 9 depicts the graphical representation of property P1 for one state of a trajectory generated by NOMINAL_x. Case 1 shows that the state fulfills the requirements of P1 and Case 2 does not fulfill the representation of P1.

The purpose of RULE_x is to evaluate all properties Prop_x received by PROPERTY_x according some predefined rules (see FIG. 4). Rules combine the results of properties using different logical operators. This can contain classical logical operators like and, or, and not. Logics can also contain temporal operator like always, until, next, etc., as defined in linear temporal logic, or time constraints as defined in signal temporal logics, spatial constraints as defined in spatial logics. Other potential logics are denotic logics or doaxtic logics. The rules are defined through CONFIGURE_x, as described above. Instead of the functions, logical operators are used. The rules are applied in two ways. One way is to use binary logic with only 0 and 1 values. The second way is to use probabilistic approach, which entail a range of values between 0 and 1. A logical operation “a and b” can be probabilistically calculated as “a−b” in the case a and b are independent of each other or “P(a and b)=P(a|b)·P(b)” in the case a depends on b. To convert the probabilistic results into 0 or 1 a threshold value is defined where the probabilistic result is compared to. If it is above the result is one 1 or if it is below it is 0. This could also be defined the other way around.

Objects are the interface of the Copilot to the customer application. A typical object measurement can consist of an object label, object detection probability, object model, the measurement and the measurement uncertainties. The object label describes the name of the object, e. g. yield sign, bicycle, etc. The object detection probability describes the probability that the detected object is actually the object with the given object label. The object model describes the dynamic model of an object, in this case a dynamic object. The measurement describes the state measurement of the object (position, velocity, etc.). The object uncertainty describes the uncertainty of the state measurement. All objects containing the same object model are mapped to their representation in DYN_OBJ_x. All objects containing no dynamic model, but the same measurements are mapped to the equivalent object representation in STAT_OBJ_x.

The probabilistic verification method is typically used in CHANNEL_A to verify the nominal path planner. The verification of CHANNEL_B is typically done using the classical logic with 0 and 1.

In a known implementation of the SWITCH (cf. FIG. 3) either one of the channels can be used, as long as their respective results (ErrCmp_A=0 or ErrCmp_B=0) do not indicate an error (OutSelceted=Out_A or OutSelected_B). In that case, the embodiments described herein use a channel priority. FIG. 10 depicts the functionality of the SWITCH where Channel_A has a higher priority than Channel_B. The channel with the highest priority can be the channel that contains features which are preferred to control the mechatronic system (e. g. minimization of the jerk while driving or flying) while the channel with the lower priority can have features with lower priority e. g. to bring the mechatronic system into a safe state. In the case that one of the two channels (ErrCmp_A=1 or ErrCmp_B=1) indicates an error, the channel without error indication is used, which means ErrCmp_A=0 results to OutSelected=Out_A and ErrCmp_B=0 results to OutSelected=Out_B. If both channels indicate an error at the same time (ErrCmp_A=1 and ErrCmp_B=1), then a control action/emergency action is taken to bring the system into fail-silent as quick as possible which results to OutSelected=OutEmergency.

A user interface (UI) for the configuration of control and non-control systems may be implemented in order give the user the possibility to review the current system configuration, parameters and features. If necessary, the user will be able to modify certain configuration files, rule sets as well as parameters and features.

As described in the lines above, the system can be reconfigured during startup by just changing the rule set.

In the case of an emergency it should be possible to prove which rules are violated. All data which have a direct link to some rules are saved for a predefined period of time (e. g. 10 s). An offline program is used to visualize and track the data. In the case a rule is violated a notification in the offline program should appear.

Embodiments and concepts described herein are summarized below. It is understood that the following is not an exhaustive enumeration of technical features but rather an exemplary summary of important aspects.

One embodiment relates to a method for controlling mechatronic systems (e.g. a vehicle, an autonomous car, an aircraft or the like) is described herein. The method includes planning a nominal path for the mechatronic system using an automatic path planner (cf. FIG. 4, NOMINAL_A, NOMINAL_B). Various suitable path planers are known as such and thus not further described herein. The method further includes receiving (e.g., from a sensor system included in the mechatronic system) information (cf. FIG. 4, ObjList_A, ObjList_B) concerning one or more objects detected in the surrounding environment of the mechatronic system. This information is used to calculate one or more occupancy sets corresponding to the one or more detected objects. The received information may include, inter alia, the detected (measured) state of the detected object(s) or a sequence of states or even predicted states for the object(s), as well as an object label/name which is indicative of an object type or object calls. Examples for object types are “traffic light”, “pedestrian”, “unknown obstacle”, “stop sign”, “traffic sign limiting maximum speed to 60 km/h”, “truck more than 3.5 tons”, etc. Furthermore, the method includes detecting whether the nominal path violates (intersects with) at least one of the one or more occupancy sets corresponding to the one or more detected objects.

The occupancy sets may represent theoretic system states of the mechatronic system (e.g. positions of a vehicle) which are potentially occupied by the stationary and dynamic objects at a specific time. The occupancy sets may be regarded as a set of “forbidden” states of the mechatronic system. The planned nominal path violates an occupancy set, if it intersects with the occupancy set (i.e. if a state of the planned path is also included in an occupancy set).

In one embodiment, the method may additionally include receiving a current state of the mechatronic system (cf. FIG. 4, State_A, State_B) and calculating a reachable ret corresponding to the mechatronic system, as well as detecting whether the nominal path is not a subset of the reachable set corresponding to the mechatronic system. The reachable set represents theoretic system states of the mechatronic system which the mechatronic system is able to reach due to the system dynamics of the mechatronic system. For example, if position and speed (i.e. the physical state) of a vehicle is known (from measurements) and given system parameters such as maximum acceleration and maximum deceleration as well as maximum steer angle, all possible state that the vehicle can reach in a specific time can be determined. If the planned nominal path includes—for a specific time instant currently considered—a state which is not part of the reachable set, then the planned nominal path is not physically viable. In the planned nominal path includes states which are outside the reachable set and/or which are inside of the occupancy set, then an error may be signaled.

The occupancy set is determined based on the detected states of the detected object(s) and one or more rules associated with the detected object(s). The rules may be linked to the detected objects via the mentioned object label/name. It is thus possible to use different rules for different objects (e.g. for a pedestrian or a stop sign). When a state being determined as being included in an occupancy set does not necessarily mean that the state is physically occupied by the object. A state may also be considered as “occupied” (or considered as “forbidden” for the mechatronic system) due to rule related to a detected object. For example, when the detected object is a stop sign or a traffic light showing red, then the whole space beyond the stop sign/traffic light may be considered as occupied and included in the respective occupancy set for the stop sign/traffic light.

Detecting whether a planned nominal path violates an occupancy set is not necessarily a yes/no (true/false) decision. Alternatively, a probabilistic approach may be used. In this case detecting whether the nominal path violates an occupancy set may include calculating a probability value indicative of the probability with which the nominal path violates the respective occupancy sets or one of the relevant occupancy sets.

The method summarized above may be performed in parallel in two different channels (see FIG. 3, Channel A and Channel B), wherein the two channels may be supplied with the same or with different (redundant) sensor date. That is, in the example of FIG. 3, ObList_A and ObjList_B may be identical or differ due to different sensor systems are used to obtain the data. In one channel, e.g. channel B, the nominal path planner may be programmed to drive the mechatronic system in a safe state, e.g. bring the vehicle to a safe halt. For this purpose the rules linked to the object(s) and used to determine the occupancy sets may be different. For example, leaner rules may be used in a critical situation to bring the mechatronic system to a safe halt (i.e. a safe halt should not be jeopardized by strictly obeying all existing traffic rules. The set of rules used during operation may be updated before operation of the mechatronic system is started or downloaded from a data base. The rules may also be updated dependent on the position of the mechatronic system (e.g. when the vehicle moves into an area where different rules apply as before. As mentioned, concepts for converting rules from a textual description (e.g. laws including traffic rules) into a digital representation are as such known.

Although the invention has been illustrated and described with respect to one or more implementations, alterations and/or modifications may be made to the illustrated examples without departing from the spirit and scope of the appended claims. In particular with regard to the various functions performed by the above described components or structures (units, assemblies, devices, circuits, systems, etc.), the terms (including a reference to a “means”) used to describe such components are intended to correspond—unless otherwise indicated—to any component or structure which performs the specified function of the described component (e.g., that is functionally equivalent), even though not structurally equivalent to the disclosed structure which performs the function in the herein illustrated exemplary implementations of the invention.

1-20. (canceled)

21. A method, comprising:
planning a nominal path for a mechatronic system using an automatic path planner;
receiving information concerning one or more objects detected in a surrounding environment of the mechatronic system and calculating one or more occupancy sets corresponding to the one or more detected objects; and
detecting whether the nominal path violates at least one of the one or more occupancy sets.

22. The method of claim 21, wherein the one or more occupancy sets represents theoretic system states of the mechatronic system which are potentially occupied by stationary and dynamic objects.

23. The method of claim 21, further comprising:
receiving a current state of the mechatronic system and calculating a reachable set corresponding to the mechatronic system; and
detecting whether the nominal path is not a subset of the reachable set corresponding to the mechatronic system.

24. The method of claim 23, further comprising:
signaling an error in response to detecting that the nominal path is not a subset of the reachable set corresponding to the mechatronic system.

25. The method of claim 23, wherein the reachable set represents theoretic system states of the mechatronic system, which the mechatronic system is able to reach due to system dynamics of the mechatronic system.

26. The method of claim 21, further comprising:
signaling an error in response to detecting that the nominal path violates at least one of the one or more occupancy sets.

27. The method of claim 21, wherein the one or more occupancy sets is determined based on detected states of the detected one or more objects and one or more rules associated with the detected one or more objects.

28. The method of claim 27, wherein the information concerning the detected one or more objects includes data concerning the state of the one or more objects and an object label designating a type of the object, and wherein the detected one or more objects are associated with the one or more rules based on the object label.

29. The method of claim 27, further comprising:
updating a rule set including the one or more rules.

30. The method of claim 21, wherein the information concerning the detected one or more objects includes data concerning the state of the one or more objects and an object label designating a type of the object.

31. The method of claim 21, wherein the information concerning the detected one or more objects includes data concerning the state of the one or more objects, uncertainties associated with the states, and an object label designating a type of the one or more objects.

32. The method of claim 31, wherein detecting whether the nominal path violates at least one of the one or more occupancy sets comprises calculating a probability value indicative of the probability with which the nominal path violates at least one of the one or more occupancy sets.

33. The method of claim 21, wherein the nominal path is composed of one or more planned states of the mechatronic system associated with one or more corresponding time instants, and wherein the one or more occupancy sets and one or more reachable sets are determined for each of the corresponding time instants.

34. A method, comprising:
in a first channel:
planning a first nominal path for a mechatronic system using a first automatic path planner;
receiving first information concerning one or more first objects detected in a surrounding environment of the mechatronic system and calculating one or more first occupancy sets corresponding to the one or more first detected objects; and
detecting whether the first nominal path violates at least one of the one or more first occupancy sets;
in a second channel:
planning a second nominal path for the mechatronic system using a second automatic path planner;
receiving second information concerning one or more second objects detected in the surrounding environment of the mechatronic system and calculating one or more second occupancy sets corresponding to the one or more second detected objects; and
detecting whether the second nominal path violates at least one of the one or more second occupancy sets;
selecting either the first nominal path or the second nominal path based on which one of the first nominal path and the second nominal path does not violate the respective one or more occupancy sets.

35. The method of claim 34, wherein the first nominal path, which has a higher priority, is selected when both the first nominal path and the second nominal path do not violate the respective one or more occupancy sets.

36. The method of claim 34, wherein in the first channel, the detecting whether the first nominal path violates at least one of the one or more first occupancy sets comprises calculating a probability value indicative of the probability with which the first nominal path violates at least one of the one or more first occupancy sets.

37. The method of claim 34, further comprising:
selecting an emergency maneuver when both the first nominal path and the second nominal path violate the respective one or more occupancy sets.

38. The method of claim 34, wherein in the first channel and the second channel, the respective one or more occupancy sets are determined based on detected states of the respective detected one or more objects and one or more rules associated with the respective detected one or more objects, wherein the rules are different for the first channel and the second channel.

39. The method of claim 38, further comprising:
updating a rule set including the one or more rules.

40. The method of claim 34, wherein in the second channel, the second nominal path is planned such that the mechatronic system is driven into a safe state.

41. A system, comprising:
an automatic path planner configured to plan a nominal path for a mechatronic system; and
a monitor unit configured to receive information concerning one or more objects detected in a surrounding environment of the mechatronic system and to calculate one or more occupancy sets corresponding to the one or more detected objects,
wherein the system is configured to detect whether the nominal path violates at least one of the one or more occupancy sets.
